(19) United States
(12) Patent Application Publication
(10) Pub. No.: US 2014/0115336 A1
(43) Pub. Date: Apr. 24, 2014

(54) METHOD AND APPARATUS OF PROVISIONING HOME ENERGY MANAGEMENT SERVICES

(71) Applicant: ELECTRONICS AND TELECOMMUNICATIONS RESEARCH INSTITUTE, Daejeon (KR)

(72) Inventors: TAE IN HWANG, Daejeon (KR); IL WOO LEE, Daejeon (KR)

(73) Assignee: ELECTRONICS AND TELECOMMUNICATIONS RESEARCH INSTITUTE, Daejeon (KR)

(21) Appl. No.: 14/010,970

(22) Filed: Aug. 27, 2013

(30) Foreign Application Priority Data
Oct. 18, 2012 (KR) 10-2012-0116145

(51) Int. Cl. H04L 9/32

(52) U.S. Cl. CPC H04L 9/3244
USPC 713/170

(57) ABSTRACT

A method for provisioning home energy management services includes supplying a service user with a list of home energy management services; and transmitting a request to subscribe to a service to a home energy management service provider server on a communication network. Further, the method includes performing an authentication with the home energy management service provider server and receiving a secret key for encryption and decryption of a message that is transmitted and received for the service; searching for home energy devices on a home network and transmitting a list of searched home energy devices to the home energy management service provider server; and sending the message received from the home energy management service provider server to the same home energy devices.

### CROSS-REFERENCE TO RELATED APPLICATION(S)

The present invention claims priority of Korean Patent Application No. 10-2012-0116145, filed on Oct. 18, 2012, which is incorporated herein by reference.

### FIELD OF THE INVENTION

The present invention relates to a home energy management service; and more particularly, to a method and apparatus for provisioning home energy management services, which advertises on-line a variety of home energy management services provided through a service advertisement server from the third service provider under a smart grid environment so that a service user selectively subscribes to a service that is desired by the user among the advertised services and searches home energy devices of the service user which are able to interwork with the subscribed service to set the searched home energy devices via a home energy management message provided from the service provider, thereby securely dynamically provisioning various home energy management services in compliance with a request of the service user when provisioning the home energy management services.

### BACKGROUND OF THE INVENTION

In general, an existing electrical grid has a structure of a unidirectional electric power transmission network in which few utility companies supply electricity and a plurality of users is passively supplied with the electricity as simple consumer users.

However, in recent years, as the importance of renewable energy increases, technologies related to various power storage devices including batteries of private cars are becoming more advanced, and a variety of energy equipments within the home continues to work with the existing electrical grid, a service provider pays an increased attention to the development of a new type of home energy management services.

Under such circumstances, in order to induce efficiency of power consumption by the active participation of energy consumers as well as the third service provider, development efforts of a variety of home energy management services in conjunction with smart appliances in the home is in progress.

However, AMI (Advanced Metering Infrastructure) which is centered on a smart meter being constructed by the existing utility companies is a dependent on the companies and a closed network structure. Therefore, the third service provider should separately install and provide a new terminal device, which is suitable for a provision of a new energy management service and is able to interact with a home energy device, to service subscribers. It is difficult for the third service provider to enter the market in this way due to a primary construction cost of service infrastructures required for the installation of the new terminal device.

### SUMMARY OF THE INVENTION

In view of the above, the present invention provides a method and apparatus for provisioning home energy management services, which advertises on-line a variety of home energy management services provided through a service advertisement server from the third service provider under a smart grid environment so that a service user can selectively subscribes to a service that the user desires among the advertised services and searches home energy devices of the service user which are able to interwork with the subscribed service to set the searched home energy devices via a home energy management message provided from the service provider, thereby securely dynamically provisioning various home energy management services in compliance with a request of the service user when provisioning the home energy management services.

In accordance with a first aspect of the present invention, there is provided a method for provisioning home energy management services. The method includes: supplying a service user with a list of home energy management services that subscription of the user is allowed; transmitting a request to subscribe to a service to a home energy management service provider server on a communication network which provides the home energy management service selected by the user from the list; performing an authentication with the home energy management service provider server and receiving a secret key for encryption and decryption of a message that is transmitted and received for the service; searching for home energy devices on a home network and transmitting a list of searched home energy devices to the home energy management service provider server; and ending the message received from the home energy management service provider server to the same home energy devices.

Further, the sending a message may comprise receiving the message from the home energy management service provider server; decrypting the message using the secret key; and sending the decrypted message to the same home energy devices.

Further, the supplying a service user with a list of home energy management services may comprise receiving service advertisement information from a home energy management service advertisement server on the communication network; extracting the list of home energy management services included in the service advertisement information; and outputting the extracted list of home energy management services.

Further, the home energy devices may have unique identifiers assigned thereto when making the list.

Further, the list of home energy management services may be one of a plurality of lists of home energy management services that is supplied from a plurality of home energy management service provider servers.

Further, the home energy management services may be executed on-line through the communication network.

In accordance with a second aspect of the present invention, there is provided an apparatus for provisioning home energy management services. The apparatus includes: a home energy management service subscription unit configured to make a request for the subscription to a particular home energy management service, which is selected by a user, to a home energy management service provider server which provides the home energy management services, and receive a secret key for encryption and decryption necessary for the selected home energy management service; a security memory area management unit configured to manage a secret key which is received in the home energy management services subscription unit or a memory area capable of storing security information related to the service provisioning; a home energy device management unit configured to search for home energy devices on a home network to assign unique identifiers (IDs) to the searched home energy devices and transmit a list of the searched home energy devices to the home energy management service provider server; an encryption/decryption processing unit configured to perform an encryption and decryption on a home energy management message, which is transmitted to and received from the home energy management service provider server, using the secret key; and a home energy management message processing unit configured to manage the home energy service management message being transmitted and received between the home energy management service provider server and the home energy devices.

Further, the home energy management service subscription unit may be configured to: receive a list of home energy management services that can be serviced through a communication network; and transmit a request of a home energy management service selected from the list to the home energy management service provider server that provides the selected home energy management service.

Further, the list of home energy management services may be one of a plurality of lists of home energy management services that is supplied from the home energy management service provider server.

Further, the home energy management service subscription unit may be configured to perform an authentication with the home energy management service provider server for the selected home energy service management service after transmitting the request of the selected service.

Further, the home energy management service subscription unit may be configured to: receive service advertisement information from a home energy management service advertisement server on the communication network; and extracting a list of the home energy management services included in the service advertisement information.

Further, the home energy management message may include a message made so that the home energy management service provider server controls the home energy devices in conformity with the selected home energy management service.

Further, the home energy management message processing unit may be configured to convert the home energy management message into a data format useful for the home energy devices for the provision thereof.

Further, the home energy management services may be executed on-line through the communication network.

As described above, the embodiment of the present invention has a merit that is capable of provisioning dynamically securely a variety of home energy management services in compliance with a request of a service subscriber in implementing the home energy management service provisioning by advertising on-line a variety of home energy management services provided through the service advertisement server from the third service provider under a smart grid environment so that a service user selectively subscribes to a service that the user desires among the advertised services and searching the home energy devices of a service subscriber which are able to interwork with the subscribed service to set the searched home energy devices via the home energy management message provided from the service provider.

Further, in accordance with an embodiment of the present invention, the third service provider does not necessary to separately install and provide a new terminal device, which is suitable for a provision of a new energy management service and is able to interact with a home energy device, to service subscribers in provisioning the home energy management services; and therefore, it is possible to solve an issue on the excessive construction cost required for initial infrastructure services. In addition, ultimately, the embodiment of the present invention provides an advantage to promote home energy consumption efficiency by inducing an entry into the smart grid market and competition of several service providers and inducing the development of the home energy management services with high efficiency.

### BRIEF DESCRIPTION OF THE DRAWINGS

The above and other objects and features of the present invention will become apparent from the following description of the embodiments given in conjunction with the accompanying drawings, in which:

FIG. 1 shows a configuration of a home energy management service system for provisioning home energy management services in accordance with an embodiment of the present invention;

FIG. 2 shows a detailed block diagram of an apparatus for provisioning home energy management services in accordance with an embodiment of the present invention;

FIG. 3 is a control flow diagram illustrating a procedure of provisioning home energy management services by an apparatus for provisioning home energy management services in accordance with an embodiment of the present invention; and

FIG. 4 is a sequential diagram illustrating a method of provisioning home energy management services in accordance with an embodiment of the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, the embodiments of the present invention will be described in detail with reference to the accompanying drawings.

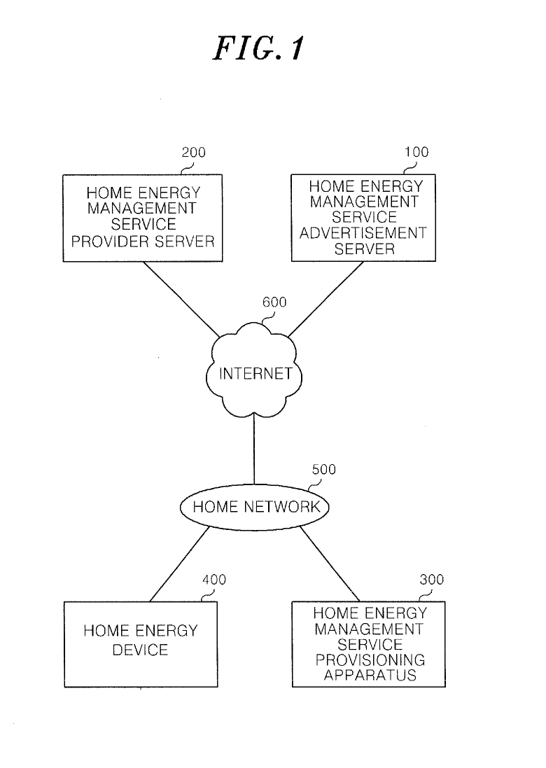

FIG. 1 shows a configuration of a home energy management service system that is capable of securely provisioning home energy management services under a smart grid environment in accordance with an embodiment of the present invention. The home energy management service system includes a home energy management service advertisement server 100, a home energy management service provider server 200, a home energy management service provisioning apparatus 300 and one or more home energy devices 400.

The operation of the respective components of the home energy management service system will be described in detail hereinafter with reference to FIG. 1.

First, the home energy management service advertisement server 100 registers information on a home energy management from a plurality of the third service providers and advertises the registered services on the home energy management service provisioning apparatus 300 of service users who desire to subscribe to the services.

The home energy management service provider server 200 authenticates the home energy management service provisioning apparatus 300 of a user who requests to subscribe to a service of the advertised services, receives a list of the home energy devices 400 that are capable of interworking with the home energy management service which the user subscribes from the home energy management service provisioning apparatus 300, and generates and transmits a home energy management message on a basis of the list of the home energy devices. Herein, the home energy management message may represent a message made to control the home energy device 400 which is subjected to the home energy management services in conformity with the service to which the user is subscribed.

The home energy management service provisioning apparatus 300 represents an apparatus that allows a user to selectively subscribe to a variety of the home energy management services under a smart grid environment, automatically search for the home energy devices 400 that are capable of interworking with the subscribed service and forwards the home energy management message to the home energy devices 400, thereby securely provisioning the home energy management services of the third service provider.

Such a home energy management service provisioning apparatus 300 is connected to the home energy devices 400 via the home network 500 and also connected to the home energy management service provider server 200 and the home energy management service advertisement server 100 through the Internet 600.

In other words, the home energy management service provisioning apparatus 300 receives a service advertisement including the home energy management service information registered by the third service provider through the home energy management service advertisement server 100 to the users for the presentation thereof and performs a service subscription authentication on the home energy management services that is selected by the service user in conjunction with the home energy management service provider server 200.

Further, the home energy management service provisioning apparatus 300 plays a role to relay the home energy management message in such a manner that searches the home energy devices 400 related to the home energy management service to which the user subscribes to transmit the same to the home energy management service provider server 200 and receives the home energy management message used for managing the home energy devices 400 from the home energy management service provider server 200 to transfer the received message to the home energy devices 400.

Each of the home energy devices 400 represents a variety of electronic devices to operate by using energy at home. Each home energy device 400 is connected to the home energy management service provisioning apparatus 300 via the home network 500 and is controlled by the home energy management message relayed from the home energy management service provisioning apparatus 300 so that it can serve the home energy management services provided by the third service provider.

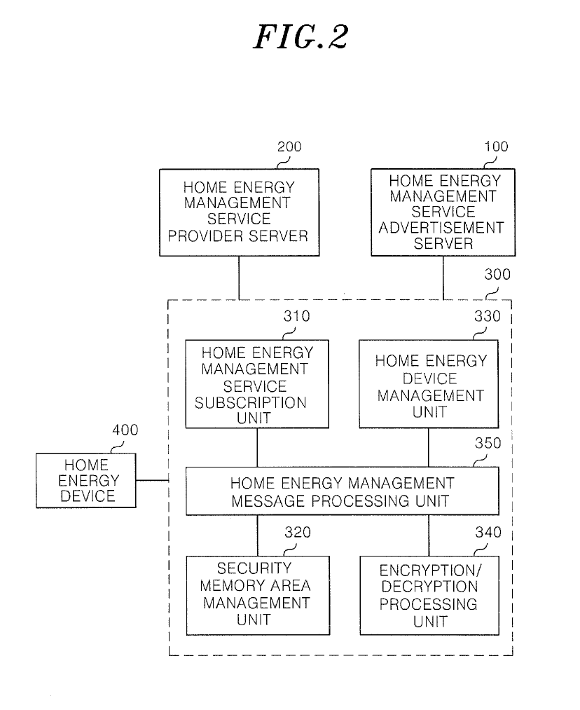

FIG. 2 shows a detailed block diagram of the apparatus 300 for provisioning the home energy management services in accordance with an embodiment of the present invention. The home energy management service provisioning apparatus 300 includes a home energy management service subscription unit 310, a security memory area management unit 320, a home energy device management unit 330, an encryption/decryption processing unit 340, and a home energy management message processing unit 350.

As described above, the home energy management service provisioning apparatus 300 allows a service user to selectively subscribe to a variety of the home energy management services under a smart grid environment, automatically search for the home energy devices 400 that are capable of interworking with the subscribed service, and forwards the home energy management message to the home energy devices 400, thereby securely provisioning the home energy management services of the third service provider at a remote location.

Hereinafter, the operation of the respective components of the home energy management service provisioning apparatus 300 will be described in detail with reference to FIG. 2.

First, the home energy management service subscription unit 310 receives the service advertisement information from the home energy management service advertisement server 100, extracts a list of the home energy management services and supplies the service user with the list of the home energy management services that subscription of the service user is allowed.

Further, when the service user requests to subscribe to a service, the home energy management service subscription unit 310 mutually authenticates with the home energy management service provider server 200 which provides the service selected by the service user, and receives a secret key for encryption and decryption of the message.

The security memory area management unit 320 manages a secret key that is received by the home energy management service subscription unit 310 and a memory area for securely storing security information related to the service provisioning.

The home energy device management unit 330 searches for the home energy devices 400 on the home network 500 to assign unique identifiers (IDs) to the searched devices and transmits a list of the searched home energy devices to the home energy management service provider server 200.

The encryption/decryption processing unit 340 encrypts and decrypts the message, which is transmitted to and received from the home energy management service provider server 200, using the secret key which is managed by the security memory area management unit 320.

The home energy management message processing unit 350 performs a data processing such as a data conversion on the home energy management message being transmitted and received between the home energy management service provider server 200 and the home energy devices 400 to provide the processed message to the home energy devices 400. For example, the home energy management message processing unit 350 may convert the home energy management message into a data format useful in the home energy devices for the provision of the same to the home energy devices.

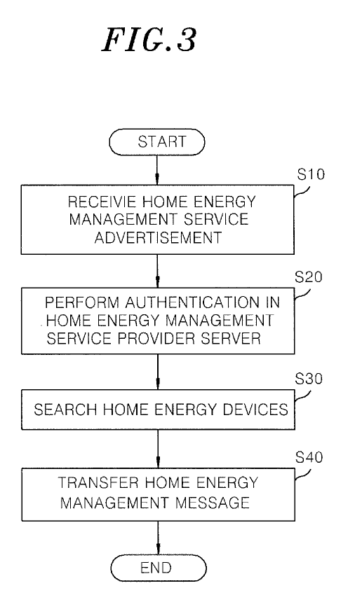

FIG. 3 is a control flow diagram illustrating a procedure of securely provisioning the home energy management services by the home energy management service provisioning apparatus 300 in accordance with an embodiment of the present invention.

As described above, the home energy management service provisioning apparatus 300 allows a user to selectively subscribe to a variety of the home energy management services under a smart grid environment, automatically search for the home energy devices 400 that are capable of interworking with the subscribed service, and forwards the home energy management message to the home energy devices 400, thereby securely provisioning the home energy management services at a remote location.

Hereinafter, the embodiment of the present invention will be described with reference to FIGS. 1, 2 and 3.

First, in an operation S10 of receiving an advertisement of the home energy management services, the home energy management service provisioning apparatus 300 receives the service advertisement information from the home energy management service advertisement server 100 and provides a list of the home energy management services to a service user.

Next, in operation S20 of performing an authentication by the home energy management service provider server, the home energy management service provisioning apparatus 300 mutually authenticates with the home energy management service provider server 200 that provides the service to which the user requests to subscribe and then receives a secret key for the encryption and decryption of the message.

Thereafter, in operation S30 of searching the home energy devices, the home energy management service provisioning apparatus 300 searches for the home energy device 400 on the home network to assign unique identifiers to the searched home energy devices and transmits a list of the searched home energy devices to the home energy management service provider server 200.

Accordingly, the home energy management service provider server 200 receives the list of the home energy devices 400 and generates the home energy management message on a basis of the list of the home energy devices to transmit the message to the home energy management service provisioning apparatus 300.

In response to the message, in operation S40 of transferring the home energy management message, the home energy management service provisioning apparatus 300 performs an encryption/decryption of the message between the home energy management service provider server 200 and the home energy devices 400 and exchanges the encrypted/decrypted message therebetween.

To put it another way, the home energy management service provisioning apparatus 300 functions to relay the home energy management message in such a manner that receives the home energy management message, which will be used for the management of the home energy devices 400, from the home energy management service provider server 200 to transfer the same to the home energy devices 400. In this regard, the home energy management message may represent a message that is able to control the home energy devices which are subjected to the home energy management services in conformity with the service to which the user subscribes.

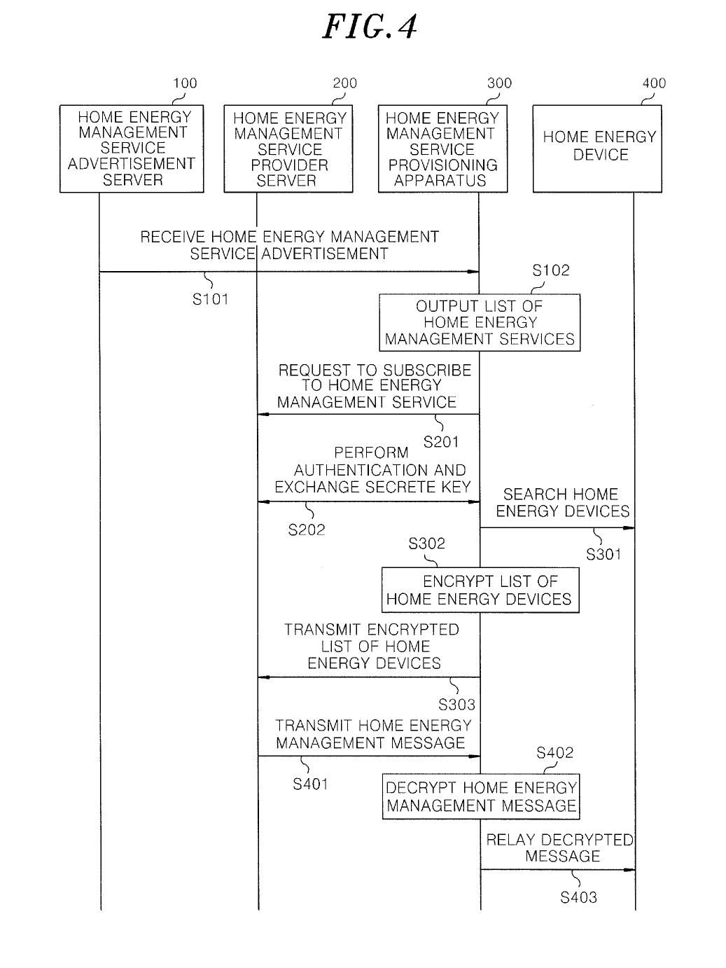

FIG. 4 is a full sequential diagram illustrating a method of securely provisioning home energy management services under a smart grid environment in accordance with an embodiment of the present invention. Hereinafter, the embodiment of the present invention will be described with reference to FIGS. 1, 2 and 4.

First, in operation S101, the home energy management service information from the third service providers is registered in the home energy management service advertisement server 100 and the home energy management service advertisement including the registered services is sent to the home energy management service provisioning apparatus 300 of the user who may desire to subscribe to one or more the services.

Next, in operation S102, the home energy management service provisioning apparatus 300 receives a list of the home energy management services that are registered in the home energy management service advertisement server 100 and pushes the received list of the home energy management services to a mobile terminal of the service user.

In response thereto, the service user reviews the list of the home energy management services and selects a desired service to make a request for a subscription to the selected service.

As such, when there is the subscription request to the home energy management service from the service user, the home energy management service provisioning apparatus 300 transmits a subscription request message to the home energy management service to the home energy management service provider server 200 in order to process the subscription request to the service to which the user wants to subscribe among the list of the home energy management services, in operation S201.

Thereafter, when the subscription request message to the home energy management service is transmitted, a mutual authentication for the performance of the home energy management and an exchange of the secret key for the encryption and decryption of the home energy management message are performed between the home energy management service provider server 200 and the home energy management service provisioning apparatus the home energy management service provisioning apparatus 300, in operation 5202.

Subsequently, when the exchange of the secret key between the home energy management service provider server 200 and the home energy management service provisioning apparatus 300 is successfully made, the home energy management service provisioning apparatus 300 searches the home energy device 400 for energy production, energy consumption or energy management connected to the home network the home network 500, in operation 5301.

When the home energy devices 400 are searched, the home energy management service provisioning apparatus 300 makes a list of the searched home energy devices and encrypts the list, in operation S302.

After that, in operation S303, the home energy management service provisioning apparatus 300 transmits the encrypted list of the home energy devices to the home energy management service provider server 200.

In operation S401, the home energy management service provider server 200 generates the home energy management message capable of performing the home energy management of the home energy devices on a basis of the list of the home energy devices and transmits the encrypted home energy management message to the home energy management service provisioning apparatus 300.

In operation S402, the home energy management service provisioning apparatus 300 decrypts the encrypted home energy management message that has been received in the operation S401 using the secret key that has been received during the operation of the authentication and key exchange.

Next, in operation S403, the home energy management service provisioning apparatus 300 relays the home energy management message decrypted in the operation S402 to the home energy devices 400 that are specified.

As set for the above, the embodiment of the present invention is capable of provisioning dynamically securely a variety of home energy management services in compliance with a request of a service subscriber in implementing the home energy management service provisioning by advertising on-line a variety of home energy management services provided through the service advertisement server from the third service provider under a smart grid environment so that a service user selectively subscribes to a service that the user desires among the advertised services and searching the home energy devices of the service user which are able to interwork with the subscribed service to set the searched home energy devices via the home energy management message provided from the service provider.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for provisioning home energy management services, the method comprising:
supplying a service user with a list of home energy management services that subscription of the user is allowed to;
transmitting a request to subscribe to a service to a home energy management service provider server on a communication network which provides the home energy management service selected by the user from the list;
performing an authentication with the home energy management service provider server and receiving a secret key for encryption and decryption of a message that is transmitted and received for the service;
searching for home energy devices on a home network and transmitting a list of searched home energy devices to the home energy management service provider server; and
sending the message received from the home energy management service provider server to the same home energy devices.

2. The method of claim 1, wherein said sending a message comprises:
receiving the message from the home energy management service provider server;
decrypting the message using the secret key; and
sending the decrypted message to the same home energy devices.

3. The method of claim 1, wherein said supplying a service user with a list of home energy management services comprises:
receiving service advertisement information from a home energy management service advertisement server on the communication network;
extracting the list of home energy management services included in the service advertisement information; and
outputting the extracted list of home energy management services.

4. The method of claim 1, wherein the home energy devices have unique identifiers assigned thereto when making the list.

5. The method of claim 1, wherein the list of home energy management services is one of a plurality of lists of home energy management services that is supplied from a plurality of home energy management service provider servers.

6. The method of claim 1, wherein the home energy management services are executed on-line through the communication network.

7. An apparatus for provisioning home energy management services, the apparatus comprising:
a home energy management service subscription unit configured to make a request for the subscription to a particular home energy management service, which is selected by a user, to a home energy management service provider server which provides the home energy management services, and receive a secret key for encryption and decryption necessary for the selected home energy management service;
a security memory area management unit configured to manage a secret key which is received in the home energy management services subscription unit or a memory area capable of storing security information related to the service provisioning;
a home energy device management unit configured to search for home energy devices on a home network to assign unique identifiers (IDs) to the searched home energy devices and transmit a list of the searched home energy devices to the home energy management service provider server;
an encryption/decryption processing unit configured to perform an encryption and decryption on a home energy management message, which is transmitted to and received from the home energy management service provider server, using the secret key; and
a home energy management message processing unit configured to manage the home energy service management message being transmitted and received between the home energy management service provider server and the home energy devices.

8. The apparatus of claim 7, wherein the home energy management service subscription unit is configured to:
receive a list of home energy management services that can be serviced through a communication network; and
transmit a request of a home energy management service selected from the list to the home energy management service provider server that provides the selected home energy management service.

9. The apparatus of claim 8, wherein the list of home energy management services is one of a plurality of lists of home energy management services that is supplied from the home energy management service provider server.

10. The apparatus of claim 7, wherein the home energy management service subscription unit is configured to perform an authentication with the home energy management service provider server for the selected home energy service management service after transmitting the request of the selected service.

11. The apparatus of claim 7, wherein the home energy management service subscription unit is configured to:
receive service advertisement information from a home energy management service advertisement server on the communication network; and
extracting a list of the home energy management services included in the service advertisement information.

12. The apparatus of claim 7, wherein the home energy management message includes a message made so that the home energy management service provider server controls the home energy devices in conformity with the selected home energy management service.

13. The apparatus of claim 7, wherein the home energy management message processing unit is configured to convert the home energy management message into a data format useful for the home energy devices for the provision thereof.

14. The apparatus of claim 7, wherein the home energy management services are executed on-line through the communication network.
